(19) United States
(12) Patent Application Publication
(10) Pub. No.: US 2023/0029031 A1
(43) Pub. Date: Jan. 26, 2023

(54) RING FOR MECHANICALLY CONNECTING TWO HOROLOGY COMPONENTS

(71) Applicant: ROLEX SA, Geneva (CH)

(72) Inventors: Nicolas Fatio, Grand-Lancy (CH); Romuald Flavignie, Thorens-Glières (FR); Jean-Baptiste Robin, Annemasse (FR)

(73) Assignee: ROLEX SA, Geneva (CH)

(21) Appl. No.: 17/865,779

(22) Filed: Jul. 15, 2022

(30) Foreign Application Priority Data
Jul. 22, 2021 (EP) 21187299.9

(51) Int. Cl. G04B 19/14; G04B 13/02; G04D 3/00

(52) U.S. Cl. CPC G04B 19/14; G04B 13/02; G04D 3/002; G04D 3/0048

(57) ABSTRACT

Ring (1) for mechanically connecting a first horology component (2) to a second horology component (3), the ring having at least one first elastic arm (11) arranged and/or configured in such a way as to press against a first horology component (2); and at least one second elastic arm (12) arranged and/or configured in such a way as to press against a second horology component (3).

This application claims priority of European patent application No. EP21187299.9 filed Jul. 22, 2021, the content of which is hereby incorporated by reference herein in its entirety.

### BACKGROUND ART

The invention relates to a ring for mechanically connecting a first horology component to a second horology component. The invention also relates to a horology assembly, notably a timepiece movement, comprising such a ring. The invention also relates to a timepiece comprising such a ring or such a horology assembly.

Most dials known from the prior art have feet. These feet are usually attached to an underside surface of the dial and are intended to sit in bores formed on an upper face of a frame of a timepiece. Screws arranged within the frame are used to press against the feet and immobilize them to prevent the dial and the frame from becoming dissociated. This fixing has the first disadvantage of not being convenient because several small-sized screws have to be manipulated. A second disadvantage that it has is that it is bulky, and may therefore be difficult to implement on watches provided with multiple functions which need to occupy a large proportion of the available surface area, such as in the case of a calendar watch. The use of a skirted dial like the one that forms the subject matter of patent application EP2743783 is itself difficult to suit the fitting of levers for correcting and/or actuating one or more functions at the periphery of a timepiece movement.

As an alternative to the solution of holding dial feet in place using screws, document CH368750 discloses a connecting ring in the form of a hollow cylindrical sleeve made of synthetic material, particularly polyamide or rubber. The exterior periphery of the sleeve is driven into a countersink formed within a timepiece movement blank, while a dial foot is held with a small amount of friction within the cylindrical opening of the sleeve. To do this, the respective diameters of the opening and of the foot are toleranced to obtain a slight interference fit of the foot in the opening. The choice of a sleeve made from a synthetic material makes it possible to avoid any problem of sticking between the sleeve and the dial foot.

Document U.S. Pat. No. 4,150,538 also relates to such a sleeve made of a synthetic material. That document more particularly discloses a specific geometry of sleeve, which has the special feature of comprising an opening the side walls of which are inclined in order to better receive a dial foot.

Document CH590508 discloses a connecting ring made of a plastics material such as nylon, which takes the form of a two-pronged clip. This clip has a horseshoe-shaped geometry. It is provided with two elastic portions distributed symmetrically and which are intended to grip a dial foot. The outer part of the ring is itself intended to be held as a close fit in a countersink in a plate of a timepiece movement. The ring is thus held within the movement by the fit between the diameter of the partially cylindrical periphery of the exterior part of the ring and the diameter of the countersink intended to accept said ring.

Because of their arrangement, the rings of the afore-mentioned documents produce forces of retention within a blank and/or forces of clamping of a dial foot which may prove to be too weak and/or to vary appreciably according to variations in the tolerances on the elements involved in the assembly device. Moreover, the synthetic materials mentioned are particularly prone to aging, and in particular to creep.

Document CH622661 proposes a connecting ring solution for connecting a dial foot to a plate which is in the form of a hollow metal sleeve that can notably be obtained by turning. This sleeve comprises elastic portions formed of slots made on the periphery of the sleeve, which extend in a direction perpendicular to a surface along which the plate intended to receive said sleeve extends. In other words, these elastic portions extend in a direction parallel to the direction in which the dial foot intended to collaborate with said sleeve extends. When the sleeve is being fitted into the plate, the elastic portions are stressed in bending so as to fit said sleeve into a bore in the plate and thus hold it in position. When the dial is being fitted, the foot is introduced into the sleeve and thus stresses the elastic portions in bending, thereby ensuring adequate retention of the dial with respect to the plate. On the one hand, such a sleeve is particularly bulky in the axial direction of the dial foot. On the other hand, the elastic portions are intended both to allow the sleeve to be assembled in the plate and to allow the foot to be assembled in the sleeve. The force of retention of the dial foot is thus defined, at least in part, by the requirements of assembling the sleeve in the plate.

A braking element is disclosed for example in document EP3396470. This element comprises first elastic portions intended to press against a first component, particularly a staff of a seconds wheel. It also comprises a solid portion to allow it to be integrated into the movement, particularly a blank. This solid portion may notably comprise a fork which provides relative axial retention thereof to a blank and to a latch. Assembling such a portion, particularly fixing such a portion notably within a blank, may prove tricky, and all the more so if the component is made of a fragile or micromachinable material.

### SUMMARY OF THE INVENTION

It is an object of the invention to provide a ring able to improve the devices known from the prior art and to overcome the disadvantages mentioned. In particular, the invention proposes a simple ring able to make controlled and reliable mechanical connection between two horology components.

According to the invention, a mechanical connection ring is defined by point 1 below.

1. A ring for mechanically connecting a first horology component to a second horology component, the ring comprising:
at least one first elastic arm arranged and/or configured in such a way as to press against a first horology component; and
at least one second elastic arm arranged and/or configured in such a way as to press against a second horology component.

Embodiments of the ring are defined by points 2 to 7 below.

2. The ring as defined in the preceding point, wherein the ring has an axis and wherein the at least one first elastic arm is arranged and/or configured in such a way as:
to be stressed essentially in bending as a result of its pressing against a first horology component and/or to extend substantially orthoradially relative to the axis, or
to be stressed essentially in compression as a result of its pressing against a first horology component and/or to extend substantially radially relative to the axis.

3. The ring as defined in point 1 or 2, wherein the ring has an axis and wherein the at least one second elastic arm is arranged and/or configured in such a way as:
to be stressed essentially in bending as a result of its pressing against a second horology component and/or to extend substantially orthoradially relative to the axis, or
to be stressed essentially in compression as a result of its pressing against a second horology component and/or to extend substantially radially relative to the axis.

4. The ring as defined in one of the preceding points, wherein the ring comprises a felloe, the at least one first elastic arm extending from the felloe and/or the at least one second elastic arm extending from the felloe or being comprised in the felloe.

5. The ring as defined in one of the preceding points, wherein the ring has an axis, wherein the at least one first elastic arm is arranged and/or configured in such a way as to extend substantially orthoradially relative to the axis, wherein the at least one second elastic arm is arranged and/or configured in such a way as to extend substantially orthoradially relative to the axis, and wherein the at least one first elastic arm and the at least one second elastic arm extend substantially in the same direction.

6. The ring as defined in one of points 1 to 4, wherein the ring has an axis, wherein the at least one first elastic arm is arranged and/or configured in such a way as to extend substantially orthoradially relative to the axis, wherein the at least one second elastic arm is arranged and/or configured in such a way as to extend substantially orthoradially relative to the axis, and wherein the at least one first elastic arm and the at least one second elastic arm extend in substantially opposite directions.

7. The ring as defined in one of the preceding points, wherein it is produced by implementing a micromanufacturing step such as, for example, a step of deep reactive ion etching or a UV-LIGA production step.

According to the invention, a horology assembly is defined by point 8 below.

8. A horology assembly, particularly a timepiece movement, comprising:
a ring as defined in one of the preceding points,
a first horology component, and
a second horology component.

Embodiments of the assembly are defined by points 9 to 14 below.

9. The horology assembly as defined in the preceding point, wherein the first horology component is:
a dial, notably at least one foot of a dial, or
a wheel, notably a staff of a wheel.

10. The horology assembly as defined in point 8 or 9, wherein the second horology component is:
fixed relative to a frame, and is notably a blank, particularly a plate or a bridge, or
mobile relative to a frame, and is notably a rocker or a lever.

11. The horology assembly as defined in one of points 8 to 10, wherein the first horology component is fixed to the second horology component by means of the ring.

12. The horology assembly as defined in one of points 8 to 11, wherein the first horology component is mounted with the ability to move relative to the second horology component about an axis and wherein the first horology component and the second horology component are braked relative to one another by means of the ring, notably braked in translation along and/or in rotation about the axis.

13. The horology assembly as defined in one of points 8 to 12, characterized in that an axial force of retention of the first horology component in the connecting ring is less than 0.8 times or than 0.6 times or than 0.4 times an axial force of retention of the connecting ring in the second horology component.

14. The horology assembly as defined in one of points 8 to 13, wherein a torque of retention of the first horology component in the connecting ring is less than 10⁻³ times or than 5×10⁻⁴ times a torque of retention of the connecting ring in the second horology component.

According to the invention, a timepiece is defined by point 15 below.

15. A timepiece, notably a wristwatch, comprising a connecting ring as defined in one of points 1 to 7 and/or an assembly as defined in one of points 8 to 14.

### BRIEF DESCRIPTION OF THE DRAWINGS

The attached drawings depict, by way of example, two embodiments of a timepiece.

FIG. 1 is a view of a first embodiment of a timepiece.

FIG. 2 is a partial section view of a first embodiment of an assembly.

FIGS. 3 to 5 are partial views from above of the first embodiment of the assembly.

FIG. 6 is a partial section view of a variant of the first embodiment of the assembly.

FIGS. 7 and 8 are views illustrating a second use of a first embodiment of a mechanical connection ring.

FIGS. 9 and 10 are views illustrating a third use of the first embodiment of the mechanical connection ring.

FIG. 11 is a partial view of a second embodiment of a timepiece.

FIGS. 12 and 13 are partial views from above of a second embodiment of the assembly.

### DETAILED DESCRIPTION OF PARTICULAR EMBODIMENTS

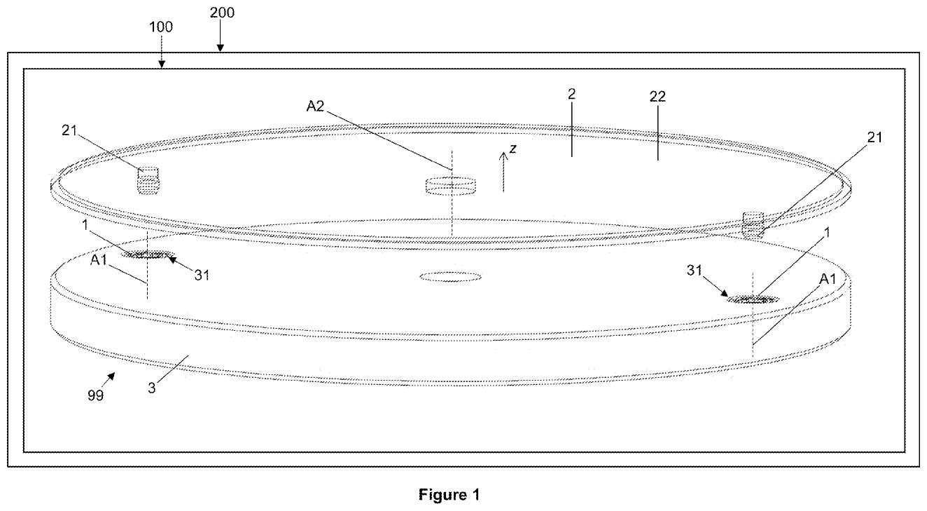

One embodiment of a timepiece 200 is described in detail hereinafter with reference to FIGS. 1 to 10.

The timepiece 200 is, for example, a watch, particularly a wristwatch. The timepiece 200 comprises an assembly 100, particularly a timepiece movement 100, which is intended to be mounted in a casing or case of the timepiece so as to protect it from the external environment. The timepiece movement 100 may be a mechanical movement, notably an automatic movement, or an electronic movement, or else a hybrid movement.

The assembly 100, particularly the timepiece movement 100, comprises:
a first horology component 2; 4,
a second horology component 3, and
a mechanical connection ring 1 allowing the first and second components to be mechanically connected with defined and controlled characteristics.

In other words, the ring allows the first horology component to be mechanically connected to the second horology component, notably allowing a fixed connection of the inset type, or a sliding connection with a controlled amount of friction or a sliding pivot connection with a controlled amount of friction or a pivot connection having a controlled amount of friction.

The ring comprises:
at least one first elastic arm 11 arranged and/or configured in such a way as to press against the first horology component 2; 4; and
at least one second elastic arm 12 arranged and/or configured in such a way as to press against the second horology component 3.

In the first embodiment, the at least one first elastic arm 11 is deformable in bending so that it presses against the first component 2; 4 and/or the at least one second elastic arm 12, different than the first, is deformable in bending so that it presses against the second component 3.

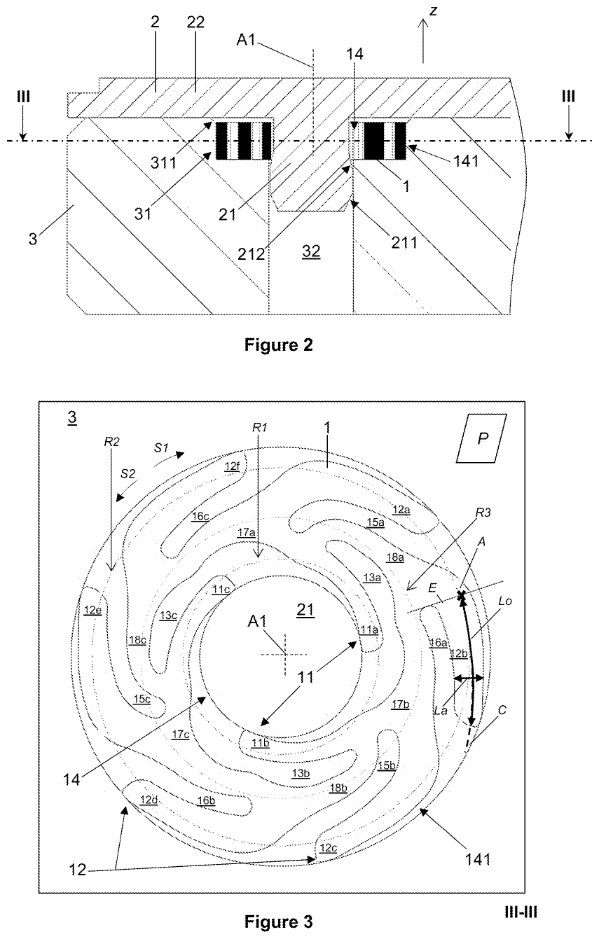

According to one advantageous implementation of the ring 1 illustrated in FIGS. 1 and 2, the first component is a dial 2, particularly a dial foot 21, and the second component is a movement blank 3, particularly a plate or a bridge.

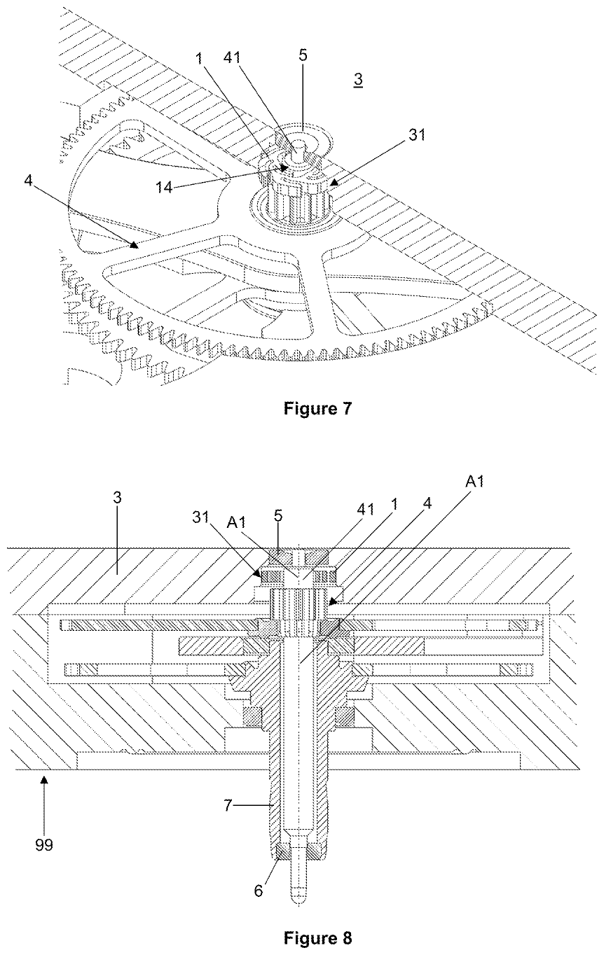

According to another advantageous implementation of the ring 1 illustrated in FIGS. 7 to 10, the first component is a horology wheel 4, particularly an arbor or staff 41 of a wheel 4, and the second component is a movement blank 3, particularly a plate or a bridge.

FIG. 1 illustrates an exploded view of the horology assembly 100 comprising the dial 2 and the blank 3, feet 21 of the dial each being connected to the blank 3 by a ring 1. As a preference, the rings may be identical. Each of these rings is intended to be housed in a countersink 31 formed in the blank 3, as is more particularly visible in the partial section view of FIG. 2.

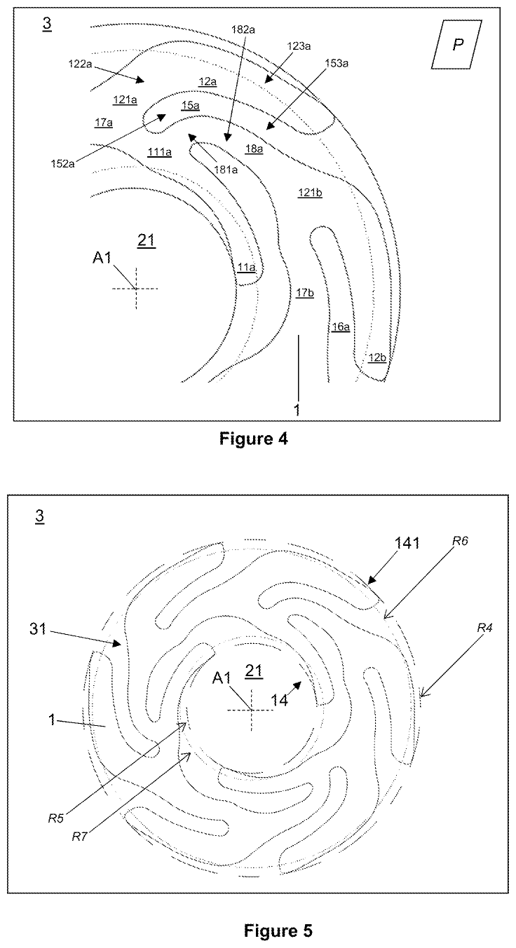

According to the specific embodiment variant of the ring that is illustrated in FIG. 3, this ring has a substantially annular geometry of axis A1, a plane P in which the ring extends being perpendicular to the axis A1 (and parallel to the plane of the figure).

The ring 1 comprises a central opening 14. This central opening 14 is intended to accept the first horology component. The ring 1 comprises an external periphery 141. This external periphery 141 is intended to be housed in the second horology component 3, notably in a shaping of the second horology component 3, such as a countersink 31.

The first and second elastic arms 11, 12 are deformable in bending in the plane P or in a plane parallel or substantially parallel to the plane P. In other words, the first and second elastic arms 11, 12 preferably extend at least substantially in the plane P.

The ring 1 specifically illustrated more particularly comprises three first elastic arms 11a, 11b, 11c which are deformable in bending. These first arms are each defined by at least one oblong slot 13a, 13b, 13c.

The first elastic arms 11a, 11b, 11c extend substantially orthoradially relative to the axis A1 at a first radius R1 measured from the axis A1, and at least partially define the opening 14 of axis A1 in which, for example, a foot 21 of the dial 2 is intended to be housed. In other words, these first elastic arms at least partially define an interior contour of the ring 1.

The first arms 11a, 11b, 11c are built in at their respective first ends 111a, 111b, 111c to first rigid or substantially rigid portions 17a, 17b, 17c. The first rigid or substantially rigid portions 17a, 17b, 17c advantageously take the form of portions that are annular or substantially annular relative to the axis A1.

As a preference, the first elastic arms are equally distributed about the axis A1.

Thus, the first elastic arms are arranged and/or configured in such a way as:
to be stressed essentially in bending as a result of their pressing against the first horology component 2; 4, and/or
to extend substantially orthoradially relative to the axis A1.

The ring 1 illustrated also comprises six second elastic arms 12a, 12c, 12e, 12b, 12d, 12f that are deformable in bending and respectively defined by oblong slots 15a, 15b, 15c, 16a, 16b, 16c.

The second elastic arms extend essentially orthoradially relative to the axis A1 at a second radius R2 measured from the axis A1, and at least partially define the exterior contour 141 of the ring 1. The second arms 12a, 12c, 12e and the second arms 12b, 12d, 12f may have two distinct shapings, as is more particularly visible in the detail view of FIG. 4.

The second arms 12a, 12c, 12e are set in at their respective first ends 121a, 121c, 121e to a first rigid or substantially rigid portion 17a, 17b, 17c.

The second arms 12a, 12c, 12e are bent and comprise a first portion 122a extending substantially radially relative to the axis A1, and a second portion 123a extending substantially orthoradially relative to that same axis A1. The bent oblong slots 15a, 15b, 15c comprise a first portion 152a extending substantially radially relative to the axis A1, and a second portion 153a extending substantially orthoradially relative to that same axis A1.

The second arms 12b, 12d, 12f are themselves built in at their respective first end 121b, 121d, 121f to second rigid or substantially rigid portions 18a, 18b, 18c projecting respectively from the ends 111a, 111b, 111c of the first elastic arms 11a, 11b, 11c. The second arms 12b, 12d, 12f extend essentially orthoradially. Oblong slots 16a, 16b, 16c delimiting the second arms 12b, 12d, 12f extend also essentially orthoradially. The second rigid or substantially rigid portions 18a, 18b, 18c are preferably bent and themselves preferably comprise first portions 181a, 181b, 181c extending substantially radially relative to the axis A1, and second portions 182a, 182b, 182c extending substantially orthoradially relative to that same axis A1 which the second elastic arms 12b, 12d, 12f are built into.

The first and second rigid portions 17a, 17b, 17c, 18a, 18b, 18c are each essentially positioned at a third radius R3 comprised between the first radius R1 and the second radius R2. These portions allow the forces applied by the first elastic arms to the first horology component 2 to be rendered independent or almost independent of those applied by the second elastic arms to the second horology component 3.

As a preference, the second arms 12a, 12c, 12e and the second arms 12b, 12d, 12f are equally distributed about the axis A1 as depicted in FIG. 3. The same is true of the first and second rigid or substantially rigid portions 17a, 17b, 17c, 18a, 18b, 18c, as depicted in FIG. 3.

Thus, the second elastic arms are arranged and/or configured in such a way as:
to be stressed essentially in bending as a result of their pressing against the second horology component 3, and/or
to extend substantially orthoradially relative to the axis A1.

The first and second rigid portions together advantageously constitute a felloe or rim, which is to say a rigid portion, from which the first and second elastic arms extend. The first elastic arms extend from an internal surface of the felloe. The second elastic arms extend from an external surface of the felloe.

One embodiment of a method for assembling a dial 2 on a blank 3 using a ring 1 is described hereinafter.

By convention, we elect to define a horizontal plane as being a plane parallel to a plate 22 of the dial 2, and the vertical direction z as being the direction perpendicular thereto and oriented upward, from the blank 3 toward the dial plate 22. With this convention, the feet 21 therefore extend vertically downward from the dial plate, and the dial 2 is fixed to the blank 3 by moving the feet 21 vertically toward the blank 3, notably respectively within the ring 1. The plane P in which the ring 1 extends corresponds or is parallel or substantially parallel to the horizontal plane and the axis A1 is parallel to the vertical axis.

A first step is to assemble at least one ring 1 in a countersink 31 of the blank 3. This is done by bringing the ring 1 vertically toward the countersink 31 until this ring is housed in this countersink. During this step, the second arms 12a, 12c, 12e, 12b, 12d, 12f are stressed in bending as a result of the fact that the dimension of the countersink, notably the diameter thereof, is slightly smaller than the dimension, notably the diameter, of the exterior contour 141 of the ring 1 defined by the second arms. More particularly, the radius R6 of the countersink, here circular, is slightly smaller than the radius R4 of the circle tangential to the second ends of the second arms at least partially defining the exterior contour 141 of the ring 1 (when the second arms are in an unstressed configuration illustrated in FIG. 5). The stressing of the second arms in bending as the ring 1 is introduced into the countersink 31 may for example be facilitated by an entry chamfer 311 formed at the entrance of the countersink 31, as illustrated in FIG. 2. The force F2 of axial retention of the ring 1 within the countersink 31 is essentially determined here by the elastic deformation of the second arms within the countersink 31. This deformation determines the force of contact of the second elastic arms with the countersink 31 bearing in mind the stiffness of the second elastic arms. This furthermore determines the force F2 of axial retention bearing in mind the coefficient of friction at the interface between the second arms and the countersink 31.

A second step is to bring at least one foot 21 vertically toward the ring 1 until this foot is housed within the opening 14 of the ring 1. During this step, the first arms 11a, 11b, 11c are stressed in bending because of the fact that the opening 14 is slightly smaller than the foot 21. More particularly, the radius R5 of the opening 14 is slightly smaller than the radius R7 of the foot when the ring 1 has not yet been stressed (as depicted in FIG. 5). The stressing of the first elastic arms in bending at the time of introduction of the foot 21 into the ring 1 may for example be facilitated by an entry chamfer 211 formed at the end of the foot 21. A second chamfer 212, known as an “exit” chamfer, may also be provided so as to immobilize the foot axially relative to the ring when this foot has at least partially passed through the ring. The force F1 of axial retention of the foot 21 in the opening 14 is essentially determined here by the elastic deformation of the first arms under the effect of the foot 21. This deformation determines the force of contact of the first elastic arms with the foot 21 bearing in mind the stiffness of the first elastic arms. This also determines the force F1 of axial retention, bearing in mind:
the geometry of the interface of the first arms and of the foot 21, and
the coefficient of friction at the interface of the first arms and the foot 21.

Advantageously, this force F1 of axial retention of the foot 21 is less than, or even very much less than, the force F2 of axial retention of the ring 1 in the countersink 31.

As a preference, at least one foot 21 also becomes housed within an opening 32 in the blank 3, which opening is at least partially superposed with the countersink 31. This may for example be a bore 32 positioned coaxially with respect to the countersink 31. Advantageously, such an opening 32 guides the foot 21 into the blank 3. Thus, as a preference, the foot 21 is held on the blank 3 by a ring 1 and is guided onto the blank 3 by an opening 32, particularly a bore 32.

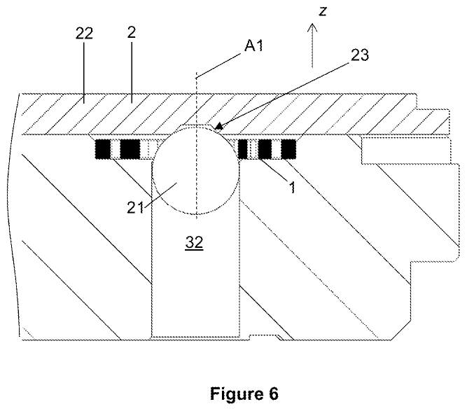

The dial feet illustrated in FIGS. 1 and 2 here have a cylindrical shape. As an alternative, their shape could be any other. For example, the feet 21 could take the form of balls, as illustrated in FIG. 6. Such a solution has the notable advantage of circumventing the problem of a lack of perpendicularity between the feet and the dial plate. These balls may be attached to the plate 22 of the dial 2 in different ways, for example by bonding or welding. Advantageously, impressions 23 may be provided to house the balls 21 in the plate 22 and allow accurate positioning of the balls on the plate.

For example, the intensity of the force F1 is approximately 3 N, and the intensity of the force F2 is approximately 10 N. More generally, the ratio F1/F2 is advantageously less than 0.8, or even less than 0.6, or even less than 0.4. Parametric optimization of the geometry of the ring 1 allows precisely the desired forces to be obtained.

The ring 1 thus acts as a retaining ring that holds the dial 2, particularly a foot 21, on the blank 3, particularly a bridge or a plate. As a preference, the dial 2 is held on the blank 3 by two feet 21 housed respectively in two rings 1. As a preference, the dial 2 is guided on the blank 3 by two feet 21 housed respectively in two openings 32, particularly housed with a very small amount of clearance in two openings 32. In order to limit the risks of static indeterminacy, the openings 32 provided for accepting each of these feet respectively may have distinct geometries or formats. For example, a first opening 32 may be circular or triangular, while a second opening 32 may have an oblong geometry, notably an oblong geometry directed at least substantially in the direction of the first opening 32. The two rings 1 may or may not be identical and the feet 21 may or may not be identical, the purpose of this being to optimize the positioning and/or the retention of the dial 2 on the blank 3 while at the same time minimizing the stresses within the rings 1.

According to another advantageous implementation, the ring 1 may alternatively act as a braking ring as illustrated in FIGS. 7 to 10. In such an implementation, the first horology component 4 is mounted with the ability to move relative to the second horology component 3 about an axis A1, and the first horology component 4 and the second horology component 3 are braked relative to one another by the ring 1, notably braked in terms of translational movement along and/or rotational movement about the axis A1.

FIGS. 7 and 8 illustrate such an application in which the ring 1, housed beforehand within the countersink 31 of the blank 3, is collaborating with an arbor 41 of a timepiece wheel 4. This wheel 4, particularly the arbor 41, passes through the opening 14 formed by the ring 1. More particularly, the arbor 41 is pivoted between two bearings, particularly between two jewels 5, 6, which allow it to be positioned coaxially or substantially coaxially with respect to the axis A1. For example, the jewel 5 is driven into the blank 3. For example also, the jewel 6 is supported by a wheel 7 positioned coaxially with the wheel 4, particularly with the arbor 41.

Advantageously, the wheel 4 is a display wheel, particularly a display wheel of an indirect gear train, namely a display wheel mounted off the main line of a main gear train. It may, for example, be a seconds display wheel. Thus, such a ring 1 is able to alleviate the problem of flutter, by generating a friction torque C1 that opposes the arbor 41 as a result of the elastic deformation of the first elastic arms 11a, 11b, 11c in contact with the arbor 41. As a preference, this friction torque C1 is of the order of 0.5 to 5 μNm and preferably less than 10 μNm. This torque C1 is thus extremely low compared with the torque C2 necessary to make the ring 1 rotate about its axis A1 within the countersink 31, which is preferably greater than 10 mNm. As a preference, the ratio C1/C2 is less than 10⁻³, or even less than 5×10⁻⁴.

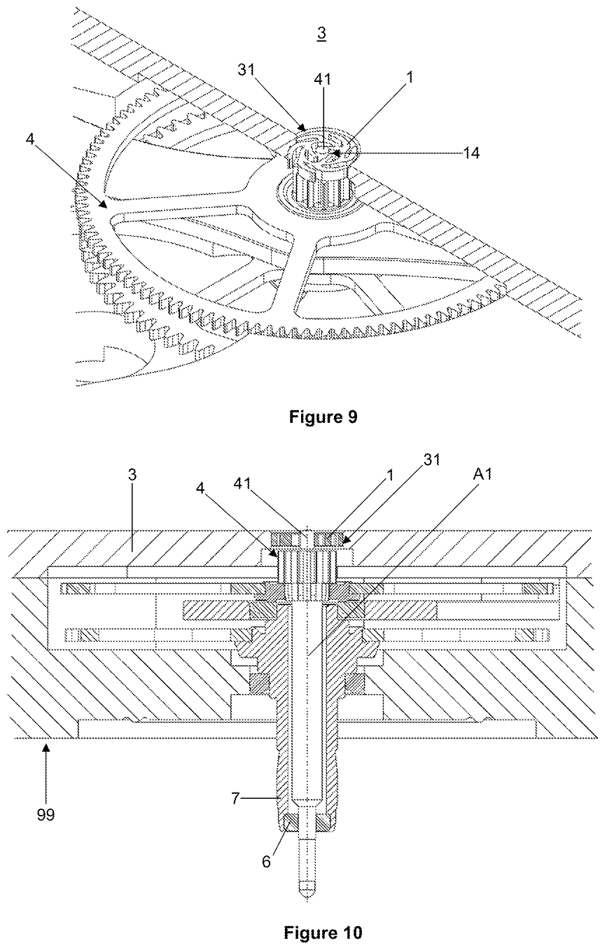

According to another particular implementation variation of the braking ring 1, this may also act as a pivot ring and thus take the place of at least one bearing. For example, FIGS. 9 and 10 illustrate such an implementation, in which the arbor 41 of the wheel 4 is pivoted in the blank 3 directly via the ring 1. The latter thus takes the place of the bearing 5 of FIGS. 7 and 8. Such an embodiment may notably be highly advantageous for the pivoting of an oscillator, particularly a balance wheel/balance spring assembly, as described in application EP3382472. In this particular scenario, the first elastic arms 11a, 11b, 11c would make it possible to minimize the differences there are between the oscillation-resisting torques of an oscillator in the various horology positions.

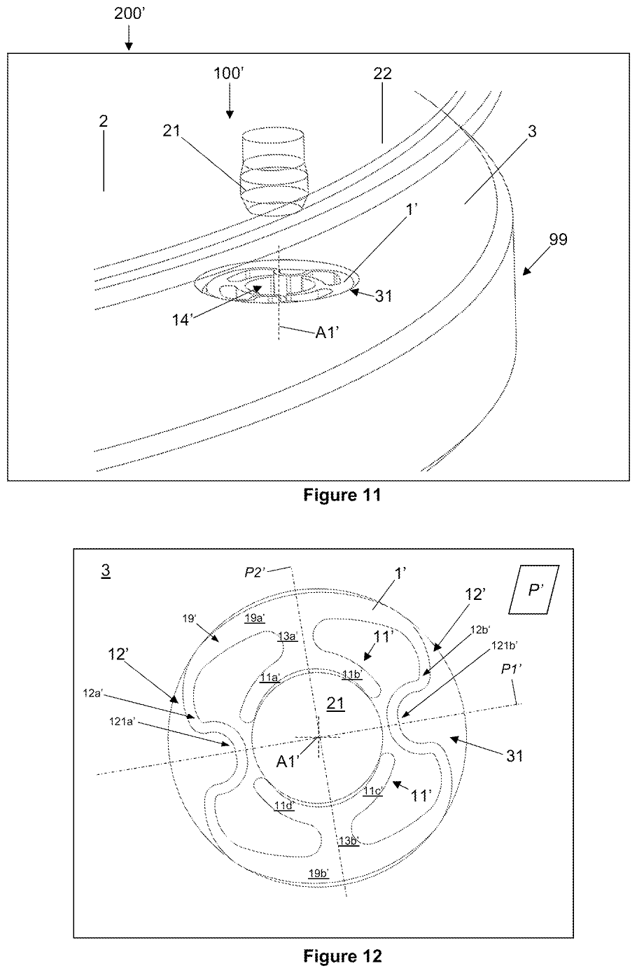

A second embodiment of a timepiece 200′ is described in detail hereinafter with reference to FIGS. 11 to 13.

The timepiece 200′ is, for example, a watch, particularly a wristwatch. The timepiece 200′ comprises an assembly 100′, particularly a timepiece movement 100′, intended to be mounted in a timepiece case or casing so as to protect it from the external environment. The timepiece movement 100′ may be a mechanical movement, notably an automatic movement, or an electronic movement or else a hybrid movement.

The assembly 100′, particularly the timepiece movement 100′, comprises:
a first horology component 2,
a second horology component 3, and
a mechanical connection ring 1′ allowing the first and second components to be mechanically connected, and particularly according to defined and controlled characteristics.

In other words, the ring 1′ allows the first horology component 2 to be connected to the second horology component 3.

The ring 1′ comprises:
at least one first elastic arm 11′ arranged and/or configured in such a way as to press against the first horology component 2; 4; and
at least one second elastic arm 12′ arranged and/or configured in such a way as to press against the second horology component 3.

FIG. 11 illustrates a partial exploded view of the assembly 100′ comprising a dial 2 and a blank 3, at least one dial foot 21 being connected to the blank 3 by the ring 1′ extending in a plane P′.

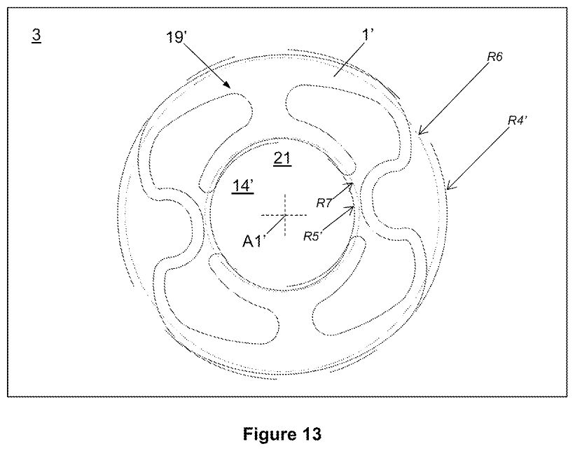

The ring 1′ more particularly visible in FIGS. 12 and 13 differs from the ring 1 in that it comprises at least one second elastic arm 12′ that can be deformed in compression so that it presses against the blank 3. This at least one elastic arm is comprised within a felloe 19′ defining the exterior periphery of the ring 1′.

More particularly, this felloe 19′ comprises two thinned portions which respectively constitute two elastic arms 12a′, 12b′. In order to encourage them to deform in compression, these two arms each have an arc-shaped portion 121a′, 121b′ the curvature of which can be modified by elastic deformation when the ring 1′ is being assembled into a countersink 31 of the blank 3.

The felloe 19′ also comprises two rigid portions 19a′, 19b′ which respectively support a pair of first elastic arms 11a′, 11b′ and 11c′, 11d′ positioned orthoradially relative to an axis A1′ of the ring 1′ so as to define an opening 14′ and thus at least partially define an interior contour of the ring 1′. As a preference, these rigid portions 19a′, 19b′ are arc-shaped.

More particularly, these pairs of first elastic arms are supported by connecting elements 13a′, 13b′ oriented radially relative to the axis A1′. As a preference, these connecting elements 13a′, 13b′ extend from the middle of the rigid portions 19a′, 19b′.

The ring 1′ here is configured symmetrically. More particularly, it comprises at least one plane of symmetry. In this particular instance, the pairs of first elastic arms 11a′, 11b′ and 11c′, 11d′ are symmetrical with respect to a first plane of symmetry P1′ perpendicular to the plane P′, and the arms 12a′, 12b′, particularly the portions 121a′, 121b′, are symmetrical with respect to a second plane of symmetry P2′ perpendicular to the plane P′. Furthermore, the first elastic arms of each of the pairs 11a′, 11b′ and 11c′, 11d′ and/or the second elastic arms 12a′, 12b′ are also symmetrical with respect to the plane P2′.

Advantageously, the planes P1′ and P2′ are perpendicular. As a preference, the first arms 11a′, 11b′, 11c′, 11d′ form arcs connected at their middles to the connecting elements. These arcs extend for example over more than 90° about the axis A1′.

Such a configuration of ring means that the forces produced by the first elastic arms can be rendered perfectly independent of those produced by the second elastic arms.

One embodiment of a method for assembling the dial 2 on a blank 3 using a ring 1′ is described hereinafter.

The procedure for assembling a dial 2 on a blank 3 involving a ring 1′ is similar or identical to the one described hereinabove with reference to the ring 1 according to the first embodiment. When not deformed (as depicted in FIG. 13), the ring 1′, and particularly the felloe 19′, is circumscribed by a radius R4′ that is greater than the radius R6 of the countersink 31. The opening 14′ itself has a radius R5′ which is smaller than the radius R7 of the foot 21. Thus, the configuration of the countersink 31 and that of the foot 21 allow the ring 1′, particularly the first and second elastic arms, to be deformed and thus allow the dial 2 to be assembled on the blank 3. In this case of application, the ratio of the forces F1′/F2′ is less than 0.8, or even less than 0.6, or even less than 0.4, F1′ being the intensity of the force produced by the first elastic arms on the first component 2 and F2′ being the intensity of the force produced by the second elastic arms on the second component 3. Parametric optimization of the geometry of the ring 1′ allows precisely the desired forces to be obtained.

Of course, in the manner of the ring 1 of the first embodiment, a ring 1′ according to the second embodiment may also act as a friction ring and possibly as a pivot ring for a horology wheel. Such a ring 1′ may also be particularly advantageous for assembling a bearing or a thrust bearing, particularly a jewel, in a blank, that is to say for fixing or mechanically connecting a bearing or a thrust bearing, particularly a jewel, in a blank.

In all of the embodiments mentioned above, the second component is a movement blank 3, particularly a plate or a bridge. However, whatever the embodiment or variant, the second horology component 3 may be:
fixed relative to a frame 99, and be notably a blank, particularly a plate or a bridge, or
mobile relative to a frame 99, and be notably a rocker or a lever.

The same may also be true of the first component.

Whatever the embodiment or variant, the ring 1; 1′ may be produced from a nickel-based alloy, notably an alloy containing a nickel content, by weight, of between 91% and 99.8% inclusive and a content by weight, of between 0.2 and 6% inclusive, or even of between 0.2 and 4% inclusive, of a second element selected from phosphorus, boron, bismuth, carbon, chlorine, calcium, indium, manganese, tin or zirconium. The ring may for example be manufactured using the method that forms the subject matter of application WO2017102661.

Whatever the embodiment or variant, the ring 1; 1′ may be obtained by implementing a micromanufacture step such as, for example, a step of deep reactive ion etching (usually designated by its English acronym “DRIE”) in the case of a component notably containing silicon, or else the UV-LIGA technology in the case of a component based, for example, on nickel.

Whatever the embodiment or variant, the geometries of the first arms and those of the second arms are preferably different or distinct. As a preference, the first arms all have identical geometries. Alternatively, the first arms may have different geometries than one another. As a preference, the second arms all have identical geometries. Alternatively, the second arms may have different geometries than one another.

In the scenario whereby the ring 1; 1′ is used for assembling a dial on a blank, it is entirely possible to drive at least one ring 1; 1′ into the dial, and to provide the blank with a foot, the latter being intended to become housed in the opening 14; 14′ formed by the ring 1; 1′ of the dial.

Whatever the embodiment or variant, the ring preferably exhibits the same cross-sectional geometry whatever the vertical position of the plane of section perpendicular to the axis A1; A1′ or substantially perpendicular to the axis A1; A1′, in the thickness of the ring, along the axis A1; A1′. Alternatively, the ring may exhibit a cross section the geometry of which evolves according to the vertical position of the plane of section perpendicular to the axis A1; A1′ or substantially perpendicular to the axis A1; A1′, in the thickness of the ring, along the axis A1; A1′. In particular, the evolution may be:
an evolution of the angular position relative to the axis A1; A1′ of the geometry of the cross section, according to the vertical position of the plane of section perpendicular to the axis A1; A1′ or substantially perpendicular to the axis A1; A1′, in the thickness of the ring, along the axis A1; A1′, it being possible for the geometry of the cross section to remain the same, and/or
an evolution in the geometry of the cross section according to the vertical position of the plane of section perpendicular to the axis A1; A1′ or substantially perpendicular to the axis A1; A1′, in the thickness of the ring, along the axis A1; A1′.

Whatever the embodiment or variant, the ring preferably has a thickness (measured parallel to the axis A1 or A1′) of between 0.05 times and 0.3 times or between 0.08 times and 0.2 times the outside diameter of the smallest circle circumscribing the ring (when the ring is unstressed).

In the embodiments or variants described above, the first elastic arms 11; 11′ are arranged or configured in such a way as to be stressed essentially in bending as a result of their pressing against the first horology component 2; 4 and/or to extend substantially orthoradially relative to the axis A1; A1′. However, as an alternative, whatever the embodiment or variant, the first elastic arms 11; 11′ may be arranged or configured in such a way as to be stressed essentially in compression as a result of their pressing against the first horology component 2; 4 and/or to extend substantially radially relative to the axis A1; A1′.

In the embodiments or variants described above, the first elastic arms 11; 11′ at least partially define an interior contour of the ring 1; 1′ and the second elastic arms 12; 12′ at least partially define an exterior contour of the ring 1; 1′. However, as an alternative, and whatever the embodiment or variant, the first elastic arms 11; 11′ may at least partially define an exterior contour of the ring 1; 1′ and the second elastic arms 12; 12′ may at least partially define an interior contour of the ring 1; 1′.

In the first embodiment described above, the second elastic arms 12 are arranged or configured in such a way as to be stressed essentially in bending as a result of their pressing against the second horology component 3 and/or to extend substantially orthoradially relative to the axis A1. However, as an alternative, and whatever the embodiment or variant, the second elastic arms may be arranged or configured in such a way as to be stressed essentially in compression as a result of their pressing against the second horology component 3 (as in the second embodiment) and/or to extend substantially radially relative to the axis A1.

In the first embodiment, as a preference,
the ring 1 comprises the axis A1,
the at least one first elastic arm 11 is arranged and/or configured in such a way as to extend substantially orthoradially relative to the axis A1,
the at least one second elastic arm 12 is arranged and/or configured in such a way as to extend substantially orthoradially relative to the axis A1, and
the at least one first elastic arm 11 and the at least one second elastic arm 12 extend in substantially the same direction S1 (as depicted by the arrow S1 in FIG. 3).

Nevertheless, as an alternative, the ring may be such that:
it comprises the axis A1,
the at least one first elastic arm 11 is arranged and/or configured in such a way as to extend substantially orthoradially relative to the axis A1,
the at least one second elastic arm is arranged and/or configured in such a way as to extend substantially orthoradially relative to the axis A1,
the at least one first elastic arm 11 and the at least one second elastic arm 12 extend in substantially opposite directions, which is to say that:
the at least one first arm extends in the direction S1 (as depicted by the arrow S1 in FIG. 3) and the at least one second arm extends in the direction S2 (as indicated by the arrow S2 in FIG. 3), or
the at least one first arm extends in the direction S2 and the at least one second arm extends in the direction S1.

As a preference, throughout this document, what is meant by an “arm” is a configuration of which the cross-sectional geometries in planes perpendicular or substantially perpendicular to the axis A1; A1′ are elongate having a length-to-width ratio greater than 2 or greater than 3 or greater than 4, or exhibit a ratio of:
length Lo (measured along a curve C of extension of a geometry along a given section) to
mean width La along the section (measured perpendicular to the curve C of extension of a geometry of a given section)
   which is greater than 2 or greater than 3 or greater than 4.

As a preference, the length Lo is measured from a point A indicated in FIG. 3 (at the non-free end of the geometry of the section) which is situated on a build-in line E. During elastic deformation of the arm (between a configuration in which the arm is unstressed and a configuration of usual or habitual stress), the point A or the line E preferably do not shift with respect to the axis of the ring, for example the shift is less than 0.05 times or than 0.03 times the external radius of the smallest circle circumscribing the ring (when the ring is unstressed; radius R4 in FIG. 5). As a preference, the line E is:
perpendicular or substantially perpendicular to the curve C, and/or
radial to the axis A1; A1′ and tangential to the closed end of an oblong slot 16a (as indicated in FIG. 3).

As a preference, the point A may be positioned on a circle of radius R2 (as indicated in FIG. 3).

As a preference, the contacts of the first arms with the first component are located some distance from the points A or lines E of building-in of the first arms. As a further preference, the contacts of the first arms with the first component are located near the free ends of the first arms.

As a preference, the contacts of the second arms with the second component are located some distance from the points or lines of building-in of the second arms. As a further preference, the contacts of the second arms with the second component are located near the free ends of the second arms.

Preferably, whatever the embodiment or the variant described above, the ring 1 for mechanical connection allows, in particular in normal or usual situations of use of the timepiece comprising the first and second components:
to mechanically secure the first and second components, i.e. to realize a complete connection (with no degree of freedom) between the first and second components. Preferably, this mechanical connection is a mechanical connection without play between the first and second components, or
to realize a sliding connection with a controlled friction between the first and second components, or
to realize a sliding pivot connection with a controlled friction between the first and second components, or
to realize a pivot connection having a controlled friction between the first and second components.

A connecting ring solution like the solutions described above may notably take the place of an assembly screw to allow a dial with feet to be assembled on a movement. Such a solution simplifies and improves the reliability of the assembling of a dial with feet to a timepiece movement. Such a solution is also less bulky, particularly in an axial or vertical direction. Such a solution also allows fine control over the forces applied by the ring on the first horology component and/or on the second horology component.

1. A ring for mechanically connecting a first horology component to a second horology component, the ring comprising:
at least one first elastic arm arranged and/or configured so as to press against a first horology component; and
at least one second elastic arm arranged and/or configured so as to press against a second horology component.

2. The ring as claimed in claim 1, wherein the ring has an axis and wherein the at least one first elastic arm is arranged and/or configured so as:
to be stressed essentially in bending as a result of its pressing against a first horology component and/or to extend substantially orthoradially relative to the axis, or
to be stressed essentially in compression as a result of its pressing against a first horology component and/or to extend substantially radially relative to the axis.

3. The ring as claimed in claim 1, wherein the ring has an axis and wherein the at least one second elastic arm is arranged and/or configured in such a way so as:
to be stressed essentially in bending as a result of its pressing against a second horology component and/or to extend substantially orthoradially relative to the axis, or
to be stressed essentially in compression as a result of its pressing against a second horology component and/or to extend substantially radially relative to the axis.

4. The ring as claimed in claim 1, wherein the ring comprises a felloe, the at least one first elastic arm extending from the felloe and/or the at least one second elastic arm extending from the felloe and/or the at least one second elastic arm being comprised in the felloe.

5. The ring as claimed in claim 1, wherein the ring has an axis, wherein the at least one first elastic arm is arranged and/or configured so as to extend substantially orthoradially relative to the axis, wherein the at least one second elastic arm is arranged and/or configured so as to extend substantially orthoradially relative to the axis, and wherein the at least one first elastic arm and the at least one second elastic arm extend substantially in a same direction.

6. The ring as claimed in claim 1, wherein the ring has an axis, wherein the at least one first elastic arm is arranged and/or configured so as to extend substantially orthoradially relative to the axis, wherein the at least one second elastic arm is arranged and/or configured so as to extend substantially orthoradially relative to the axis, and wherein the at least one first elastic arm and the at least one second elastic arm extend in substantially opposite directions.

7. The ring as claimed in claim 1, wherein the ring has been produced by implementing a micromanufacturing action.

8. A horology assembly comprising:
a ring as claimed in claim 1,
a first horology component, and
a second horology component.

9. The horology assembly as claimed in claim 8, wherein the first horology component is:
a dial, or
a wheel.

10. The horology assembly as claimed in claim 8, wherein the second horology component is fixed relative to a frame.

11. The horology assembly as claimed in claim 8, wherein the first horology component is fixed to the second horology component by the ring.

12. The horology assembly as claimed in claim 8, wherein the first horology component is mounted with the ability to move relative to the second horology component about an axis and wherein the first horology component and the second horology component are braked relative to one another by means of the ring.

13. The horology assembly as claimed in claim 8, wherein an axial force of retention of the first horology component in the connecting ring is less than 0.8 times an axial force of retention of the connecting ring the second horology component.

14. The horology assembly as claimed in claim 8, wherein a torque of retention of the first horology component in the connecting ring is less than 10⁻³ times a torque of retention of the connecting ring in the second horology component.

15. A timepiece comprising a connecting ring claimed in claim 1.

16. The ring as claimed in claim 7, wherein the micromanufacturing action a deep reactive ion etching or a UV-LIGA production action.

17. The horology assembly as claimed in claim 8, wherein the first horology component is a foot of a dial or a staff of a wheel.

18. The horology assembly as claimed in claim 8, wherein the second horology component is mobile relative to a frame.

19. The horology assembly as claimed in claim 18, wherein the second horology component is a rocker or a lever.

20. The horology assembly as claimed in claim 12, wherein the first horology component and the second horology component are braked in translation along and/or in rotation about the axis.
